(19) United States
(12) Patent Application Publication
(10) Pub. No.: US 2025/0272519 A1
(43) Pub. Date: Aug. 28, 2025

(54) RFID Tag Capable of Variable Information Based on Orientation

(71) Applicant: Comcast Cable Communications, LLC, Philadelphia, PA (US)

(72) Inventors: Adam D. Eng, Golden, CO (US); David A. Eng, Louisville, CO (US)

(21) Appl. No.: 18/590,732

(22) Filed: Feb. 28, 2024

(51) Int. Cl. G06K 7/10; G06K 19/077; H01Q 1/22

(52) U.S. Cl. CPC G06K 7/10089; G06K 19/07773; H01Q 1/2225

(57) ABSTRACT

Systems, apparatuses, and methods are described for a radio-frequency identification (RFID) tag that provides different data based on different orientations of the RFID tag. The RFID tag may include an orientation sensor such as, for example, a tilt switch that may detect an orientation of the RFID tag. When the RFID tag is determined to be in a first orientation (e.g., a vertical position), the RFID tag may provide a first data signal. When the RFID tag is determined to be in a second orientation (e.g., a horizontal position), the RFID tag may provide a second data signal. The first data signal and the second data signal may indicate different information to an RFID tag reader such as, for example, different identifications (IDs), different commands, and/or different requests.

### BACKGROUND

Conventional radio-frequency identification (RFID) tags are configured to always provide stored data when scanned by an RFID tag reader. The stored data is provided regardless of the position of the RFID tag, without possibilities of providing different types of data. Also, this may allow a bad actor to covertly obtain sensitive data stored on a conventional RFID tag. These and other shortcomings are addressed in the disclosure.

### SUMMARY

The following summary presents a simplified summary of certain features. The summary is not an extensive overview and is not intended to identify key or critical elements.

Systems, apparatuses, and methods are described for a radio-frequency identification (RFID) tag that may provide different data based on different orientations of the RFID tag. The RFID tag may include an orientation sensor such as, for example, a tilt switch that may detect an orientation of the RFID tag. When the RFID tag is determined to be in a first orientation (e.g., a vertical position), the RFID tag may provide a first data signal based on first stored data. When the RFID tag is determined to be in a second orientation (e.g., a horizontal position), the RFID tag may provide a second data signal based on second stored data. The first data signal and the second data signal may indicate different information to an RFID tag reader such as, for example, different identifications (IDs), different commands, or different requests. Also, or alternatively, the first data signal may provide valid information while the second data signal may provide invalid information or null data. For example, the first data signal may indicate a valid authorization for a financial transaction while the second data signal may indicate that the financial transaction is not authorized. By providing the first data signal only when the RFID tag is in the first orientation, sensitive data stored on the RFID tag (e.g., data confirming authorization of a financial transaction) may be prevented from being provided by the RFID tag at certain times. As a result, a bad actor is less likely to obtain sensitive data stored on the RFID tag, thereby improving the security of the sensitive data. Further, the RFID tag may cause performance of different functions based on a user orienting the RFID tag differently to provide different data signals, expanding the capabilities and usefulness of the RFID tag.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example communication network.

FIG. 2 shows example components of a computing device.

FIG. 3 shows an example RFID tag.

FIG. 4A shows an example tilt switch in a first position.

FIG. 4B shows the example tilt switch of FIG. 4A in a second position.

FIG. 5 shows an example range of orientations of an example tilt switch.

FIG. 6 shows examples of different output signals provided by the RFID tag of FIG. 3 based on different corresponding orientations of the RFID tag.

FIG. 7 shows an example RFID tag that includes a temperature detection switch.

FIG. 8 shows an example RFID tag reader.

FIG. 9 shows example orientations of the RFID tag of FIG. 3 when embedded within a hand of a person.

FIG. 10 shows example user-specific orientations for activating the RFID tag of FIG. 3.

FIG. 11 is a flow chart showing steps of an example method of an RFID tag providing data based on an orientation of the RFID tag.

FIG. 12 is a flow chart showing steps of an example method of an RFID tag reader receiving data from an RFID tag.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

A radio-frequency identification (RFID) tag may provide different data based on different orientations of the RFID tag. For example, when the RFID tag is in a first orientation (e.g., a vertical orientation), the RFID tag may provide first data, and when the RFID tag is in a second orientation (e.g., a horizontal orientation), the RFID tag may provide second data. The first data and the second data may indicate different information such as, for example, different identification (ID) codes or different commands. For example, the first data may indicate authorization of a financial transaction while the second data may indicate that a financial transaction is not authorized. The RFID tag may include an orientation sensor such as, for example, a tilt switch or other orientation detection component to detect different orientations of the RFID tag. Based on a detected orientation of the RFID tag, the RFID tag may determine corresponding data to be provided by the RFID tag.

The data provided by the RFID tag may be provided to an RFID tag reader. The RFID tag reader may facilitate performance of an instruction indicated by the data (e.g., authorization of a financial transaction). The RFID tag reader may interrogate or scan the RFID tag by sending a signal that is received by the RFID tag. The RFID tag may provide data in response to the received signal based on the orientation of the RFID tag. The data may be provided via a modulated backscattered signal. The modulated backscattered signal may be based on the received signal from the RFID tag reader. The data provided to the RFID tag reader from the RFID tag, either individually or collectively as a sequence of provided data, may indicate various information such as, for example, an ID, a command, an authorization, a request, or other information.

By varying the data provided by the RFID tag based on the orientation of the RFID tag, bad actors may be prevented from surreptitiously scanning the RFID tag to obtain sensitive data from the RFID tag. That is, the RFID tag may only provide sensitive data when positioned in a certain specific orientation, thereby reducing the likelihood that a bad actor may covertly obtain the sensitive information. Further, the RFID tag may be used to enhance security by facilitating various multi-factor authentication (MFA) tasks such as, for example, authorizing a transaction, controlling a device (e.g., operating a vehicle), or providing verified access to a device (e.g., unlocking a vehicle).

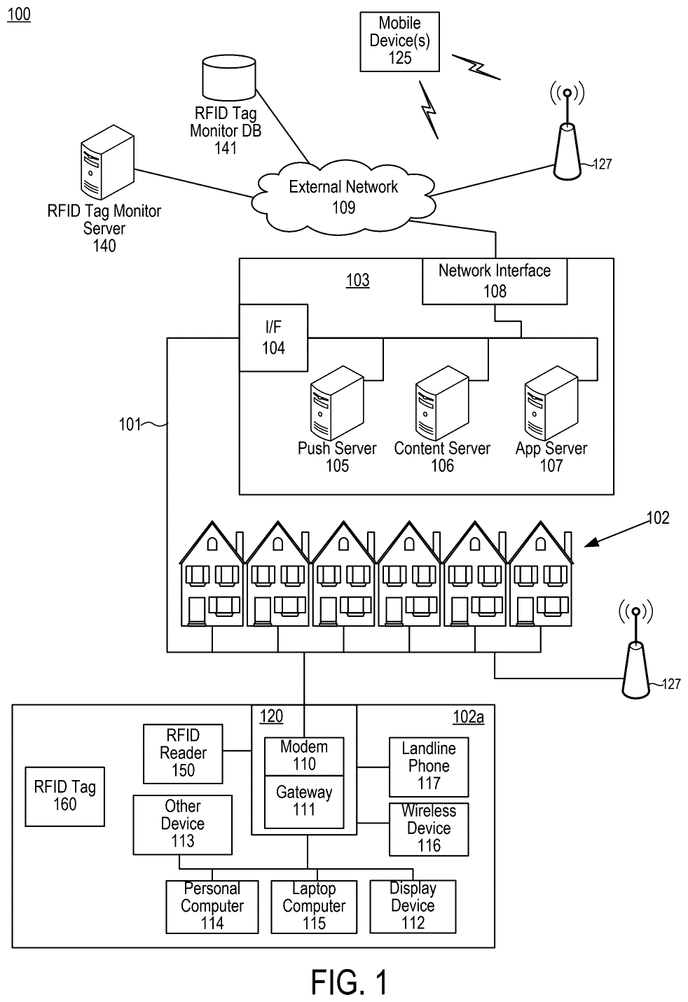

FIG. 1 shows an example communication network 100 in which features described herein may be implemented. The communication network 100 may comprise one or more information distribution networks of any type, such as, without limitation, a telephone network, a wireless network (e.g., an LTE network, a 5G network, a Wi-Fi IEEE 802.11 network, a WiMAX network, a satellite network, and/or any other network for wireless communication), an optical fiber network, a coaxial cable network, and/or a hybrid fiber/coax distribution network. The communication network 100 may use a series of interconnected communication links 101 (e.g., coaxial cables, optical fibers, wireless links, etc.) to connect multiple premises 102 (e.g., businesses, homes, consumer dwellings, train stations, airports, etc.) to a local office 103 (e.g., a headend). The local office 103 may send downstream information signals and receive upstream information signals via the communication links 101. Each of the premises 102 may comprise devices, described below, to receive, send, and/or otherwise process those signals and information contained therein.

The communication links 101 may originate from the local office 103 and may comprise components not shown, such as splitters, filters, amplifiers, etc., to help convey signals clearly. The communication links 101 may be coupled to one or more wireless access points 127 configured to communicate with one or more mobile devices 125 via one or more wireless networks. The mobile devices 125 may comprise smart phones, tablets or laptop computers with wireless transceivers, tablets or laptop computers in communication with other devices with wireless transceivers, and/or any other type of device configured to communicate via a wireless network.

The local office 103 may comprise an interface 104. The interface 104 may comprise one or more computing devices configured to send information downstream to, and to receive information upstream from, devices communicating with the local office 103 via the communications links 101. The interface 104 may be configured to manage communications among those devices, to manage communications between those devices and backend devices such as servers 105-107, and/or to manage communications between those devices and one or more external networks 109. The interface 104 may, for example, comprise one or more routers, one or more base stations, one or more optical line terminals (OLTs), one or more termination systems (e.g., a modular cable modem termination system (M-CMTS) or an integrated cable modem termination system (I-CMTS)), one or more digital subscriber line access modules (DSLAMs), and/or any other computing device(s). The local office 103 may comprise one or more network interfaces 108 that comprise circuitry needed to communicate via the external networks 109. The external networks 109 may comprise networks of Internet devices, telephone networks, wireless networks, wired networks, fiber optic networks, and/or any other desired network. The local office 103 may also or alternatively communicate with the mobile devices 125 via the interface 108 and one or more of the external networks 109, e.g., via one or more of the wireless access points 127.

The push notification server 105 may be configured to generate push notifications to deliver information to devices in the premises 102 and/or to the mobile devices 125. The content server 106 may be configured to provide content to devices in the premises 102 and/or to the mobile devices 125. This content may comprise, for example, video, audio, text, web pages, images, files, etc. The content server 106 (and/or an authentication server) may comprise software to validate user identities and entitlements, to locate and retrieve requested content, and/or to initiate delivery (e.g., streaming) of the content. The application server 107 may be configured to offer any desired service. For example, an application server may be responsible for collecting, and generating a download of, information for electronic program guide listings. Another application server may be responsible for monitoring user viewing habits and collecting information from that monitoring for use in selecting advertisements. Yet another application server may be responsible for formatting and inserting advertisements in a video stream being transmitted to devices in the premises 102 and/or to the mobile devices 125. The local office 103 may comprise additional servers, such as additional push, content, and/or application servers, and/or other types of servers. Also or alternatively, one or more servers may be part of the external network 109 and may be configured to communicate (e.g., via the local office 103) with computing devices located in or otherwise associated with one or more premises 102 and/or with mobile devices 125.

An example premises 102a may comprise an interface 120. The interface 120 may comprise circuitry used to communicate via the communication links 101. The interface 120 may comprise a modem 110, which may comprise transmitters and receivers used to communicate via the communication links 101 with the local office 103. The modem 110 may comprise, for example, a coaxial cable modem (for coaxial cable lines of the communication links 101), a fiber interface node (for fiber optic lines of the communication links 101), twisted-pair telephone modem, a wireless transceiver, and/or any other desired modem device. One modem is shown in FIG. 1, but a plurality of modems operating in parallel may be implemented within the interface 120. The interface 120 may comprise a gateway 111. The modem 110 may be connected to, or be a part of, the gateway 111. The gateway 111 may be a computing device that communicates with the modem(s) 110 to allow one or more other devices in the premises 102a to communicate with the local office 103 and/or with other devices beyond the local office 103 (e.g., via the local office 103 and the external network(s) 109). The gateway 111 may comprise (and/or otherwise perform operations of) a set-top box (STB), digital video recorder (DVR), a digital transport adapter (DTA), a computer server, a router, and/or any other desired computing device.

The gateway 111 may also comprise one or more local network interfaces to communicate, via one or more local networks, with devices in the premises 102a. Such devices may comprise, e.g., display devices 112 (e.g., televisions), other devices 113 (e.g., a DVR or STB), personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA)), landline phones 117 (e.g. Voice over Internet Protocol—VoIP phones), RFID tag reader 150, and any other desired devices. Example types of local networks comprise Multimedia Over Coax Alliance (MoCA) networks, Ethernet networks, networks communicating via Universal Serial Bus (USB) interfaces, wireless networks (e.g., IEEE 802.11, IEEE 802.15, Bluetooth), networks communicating via in-premises power lines, and others. The lines connecting the interface 120 with the other devices in the premises 102a may represent wired or wireless connections, as may be appropriate for the type of local network used. One or more of the devices at the premises 102a may be configured to provide wireless communications channels (e.g., IEEE 802.11 channels) to communicate with one or more of the mobile devices 125, which may be on- or off-premises.

The RFID tag reader 150 may be configured to interrogate or scan an RFID tag, such as RFID tag 160. The RFID tag reader 150 may scan the RFID tag 160 by sending a signal (e.g., transmitting an RF signal). The RFID tag 160 may receive the signal sent by the RFID tag reader 150. The RFID tag 160 may be configured to provide different data in response to the signal received from the RFID tag reader 150 based on the orientation of the RFID tag 160. For example, when the RFID tag 160 is in a first orientation, the RFID tag 160 may provide first data, when the RFID tag 160 is in a second orientation, the RFID tag 160 may provide second data, and when the RFID tag 160 is in an Nth orientation, the RFID tag 160 may provide Nth data.

Any type of data may be provided by the RFID tag 160. The data provided by the RFID tag 160 may be received by the RFID tag reader 150. The data provided by the RFID tag 160 may be provided via a modulated signal based on the signal received from the RFID tag reader 150. For example, the RFID tag 160 may send (e.g., transmit) a backscattered signal that may be modulated based on data that may be determined based on a particular orientation of the RFID tag 160. The RFID tag reader 150 may receive the modulated backscattered signal from the RFID tag 160 and may determine the data provided by the RFID tag 160 by demodulating the modulated backscattered signal. The data provided by the RFID tag 160 may convey various different information to the RFID tag reader 150 including, for example, an ID of RFID tag 160 and/or an instruction or a command issued by the RFID tag 160.

As a first example, when the RFID tag 160 is in a first orientation, the RFID tag 160 may provide data comprising a unique ID assigned to the RFID tag 160. When the RFID tag is in all other orientations, the RFID tag 160 may provide no data (or may provide a fake or dummy ID, or may provide null data). In this manner, the RFID tag 160 may provide sensitive data—for example, its unique ID—only when in a certain orientation. In doing so, the RFID tag 160 may be prevented from providing its unique ID at times and only when a user chooses to have the RFID tag 160 do so. In turn, this reduces the risk of a bad actor covertly scanning the RFID tag 160 to obtain any sensitive data stored on the RFID tag 160.

As a second example, when the RFID tag 160 is in a first orientation, the RFID tag 160 may provide data that may indicate authorization of a transaction. When the RFID tag is in all other orientations, the RFID tag 160 may provide no data (e.g., null data, or may provide an indication to not authorize a transaction). In this manner, the RFID tag 160 may be used as part of an MFA process to authorize a transaction only when in a certain orientation. In doing so, the RFID tag 160 may be prevented from authorizing a transaction at all times and only when a user chooses to have the RFID tag 160 do so.

As a third example, when the RFID tag 160 is in a first orientation, the RFID tag 160 may provide data that may indicate an alert or emergency signal. When the RFID tag is in all other orientations, the RFID tag 160 may provide no data (e.g., null data, or may provide an indication that there is no emergency or alert). In this manner, the RFID tag 160 may be used to signal an alarm condition (e.g., either overtly or covertly).

As a fourth example, the RFID tag 160 may be used to determine an orientation of a shipping container (e.g., a shipping box associated with the RFID tag 160 and used to transport a product). The RFID tag 160 may provide different data for each different possible orientation of the shipping container (e.g., each of six different orientations of the shipping container may cause the RFID tag 160 to provide one of six different data signals) or the RFID tag 160 may provide the same data for all acceptable orientations of the shipping container and may provide different data for all unacceptable orientations of the shipping container. In this manner, a determination as to whether the shipping container is in an acceptable orientation (e.g., the shipping container is right side up) or is in an unacceptable orientation (e.g., the shipping container has fallen over), may be quickly and easily made by scanning an area (e.g., the back of a shipping truck) containing the shipping container (e.g., the RFID tag 160 may be attached to the shipping container). This approach may be extended to determine how many shipping containers in an entire shipping truck are oriented incorrectly—for example, by scanning all of the shipping containers and paired RFID tags to determine which RFID tags return data indicating that they are oriented improperly. Unique IDs and/or unique data provided by each RFID tag in response to such scanning may allow identification of the exact shipping containers that are oriented incorrectly and therefore may be damaged.

The RFID tag reader 150 may process and/or interpret data received from the RFID tag 160 as any type of intended information such as, for example, a unique ID, an alert, a command, and/or a request to perform a certain function. Information from the RFID tag 160 may be provided via a single data signal or as a collection or sequence of data signals (e.g., such that a sequence of data provided by the RFID tag 160 is to be interpreted as providing a unique ID, an alert, a command, and/or a request to perform a certain function). The RFID tag reader 150 may receive any data provided by the RFID tag 160 and may provide the received data to any other device or component (e.g., any other device shown in FIG. 1). In doing so, any data provided by the RFID tag 160 may be used to initiate, cause, or terminate any action or function to be performed by any other device (e.g., any other device depicted in FIG. 1 or any other device communicatively coupled to the RFID tag reader 150).

The mobile devices 125, one or more of the devices in the premises 102a, and/or other devices may receive, store, output, process, and/or otherwise use data associated with content items. A content item may comprise a video, a game, one or more images, software, audio, text, webpage(s), and/or other type of content. One or more types of data may be associated with a content item. A content item may, for example, be associated with media data (e.g., data encoding video, audio, and/or images) that may be processed to cause output of the content item via a display screen, a speaker, and/or other output device component.

As described above, one or more servers may be communicatively coupled to the external network 109. For example, an RFID tag monitoring server 140 may communicate with the local office 103 (and/or one or more other local offices), one or more premises 102, one or more access points 127, one or more mobile devices 125, and/or one or more other computing devices via the external network 109 (including, for example, the RFID tag reader 150). The RFID tag monitor server 140 may monitor data received from the RFID tag 160. For example, data provided by the RFID tag 160 may be received by the RFID tag reader 150, and the RFID tag reader 150 may provide the received data to the RFID tag monitor server 140. The RFID tag monitor server 140 may also enable the mobile devices 125 to receive data from the RFID tag 160 if the mobile devices 125 are located remote from the premises 102a. The RFID tag monitor server 140 may facilitate performance of any action, request, or command based on any data received from the RFID tag 150.

Also or alternatively, the RFID tag monitor server 140 may be located in the local office 103, in a premises 102, and/or elsewhere in a network. The RFID tag monitor server 140 may communicate with an RFID tag monitor database 141. The RFID tag monitor database 141 may store data received from the RFID tag 160, may store information regarding the RFID tag 160 (e.g., an associated user, a unique ID of the RFID tag, etc.), and/or may store information related to events associated with the RFID tag 160. For example, the RFID tag monitor database 141 may store information indicating a time of day and/or a location where the RFID tag 160 was used to authorize a financial transaction. Although shown as a separate element, the RFID tag monitor database 141 may be part of the RFID tag monitor server 140. Also or alternatively, the push server 105, the content server 106, the application server 107, the RFID tag monitor server 140, and/or other server(s) may be combined. The servers 105, 106, 107, and 140, other servers, and/or the RFID tag monitor database 141 may be computing devices and may comprise memory storing data and also storing computer executable instructions that, when executed by one or more processors, cause the server(s) to perform steps described herein.

Any component depicted and described in relation to FIG. 1—including, for example, the RFID tag reader 150, the RFID tag monitor server 140, and/or the RFID monitor database 141—may receive data from the RFID tag 160 and may cause any operation or function indicated by the data or associated with the data to be performed, as further described herein.

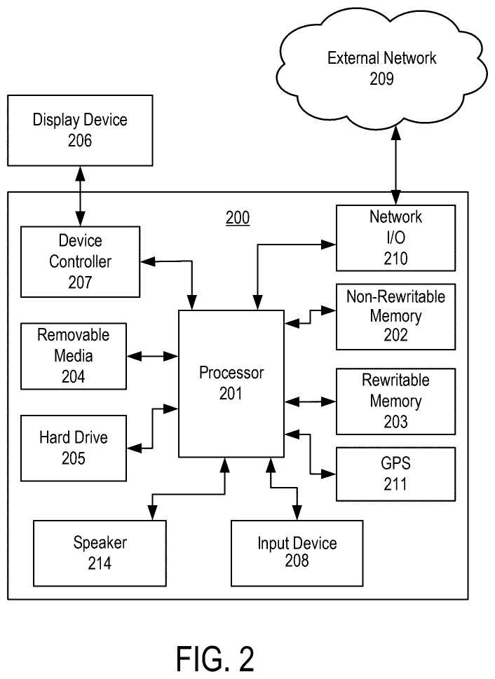

FIG. 2 shows hardware elements of a computing device 200 that may be used to implement any of the computing devices shown or described in relation to FIG. 1 (e.g., the mobile devices 125, any of the devices shown in the premises 102a, any of the devices shown in the local office 103, any of the wireless access points 127, the RFID monitor server 140, the RFID monitor database 141, the RFID tag reader 150, the RFID tag 160, any devices that are part of or associated with the external network 109) and any other computing devices discussed herein (e.g., a remote control unit associated with the gateway 111 and/or with another computing device). The computing device 200 may comprise one or more processors 201, which may execute instructions of a computer program to perform any of the functions described herein. The instructions may be stored in a non-rewritable memory 202 such as a read-only memory (ROM), a rewritable memory 203 such as random-access memory (RAM) and/or flash memory, removable media 204 (e.g., a USB drive, a compact disk (CD), a digital versatile disk (DVD)), and/or in any other type of computer-readable storage medium or memory. Instructions may also be stored in an attached (or internal) hard drive 205 or other types of storage media. The computing device 200 may comprise one or more output components, such as a display device 206 (e.g., an external television and/or other external or internal display device) and a speaker 214, and may comprise one or more output device controllers 207, such as a video processor or a controller for an infra-red or BLUETOOTH transceiver. One or more user input devices 208 may comprise a remote control, a keyboard, a mouse, a touch screen (which may be integrated with the display device 206), a microphone, etc. The computing device 200 may, for example receive sounds of speech input via a microphone. The processor 201 may (e.g., using one or more analog-to-digital (A/D) converters, digital signal processors (DSPs), and/or other components) digitize and/or otherwise generate audio data that is representative of the speech input. Also or alternatively, the computing device may comprise (e.g., in addition to the processor 201) one or more A/D converters, DSPs, and/or other components that generate audio data that is representative of the speech input. The processor 201 and/or other components of the computing device may send speech data to one or more other computing devices, may receive (e.g., via network input/output (I/O) interface 210, described below) speech data generated by another computing device, may perform speech recognition processing of speech data, and/or may perform other operations associated with speech data.

The computing device 200 may also comprise one or more network interfaces, such as the network I/O interface 210 (e.g., a network card), to communicate with an external network 209. The network I/O interface 210 may be a wired interface (e.g., electrical, RF (via coax), optical (via fiber)), a wireless interface, or a combination of the two. The network I/O interface 210 may comprise a modem configured to communicate via the external network 209. The external network 209 may comprise the communication links 101 discussed above, the external network 109, an in-home network, a network provider's wireless, coaxial, fiber, or hybrid fiber/coaxial distribution system (e.g., a DOCSIS network), or any other desired network. The computing device 200 may comprise a location-detecting device, such as a global positioning system (GPS) microprocessor 211, which may be configured to receive and process global positioning signals and determine, with possible assistance from an external server and antenna, a geographic position of the computing device 200.

Although FIG. 2 shows an example hardware configuration, one or more of the elements of the computing device 200 may be implemented as software or a combination of hardware and software. Modifications may be made to add, remove, combine, divide, etc. components of the computing device 200. Additionally, the elements shown in FIG. 2 may be implemented using basic computing devices and components that have been configured to perform operations such as are described herein. For example, a memory of the computing device 200 may store computer-executable instructions that, when executed by the processor 201 and/or one or more other processors of the computing device 200, cause the computing device 200 to perform one, some, or all of the operations described herein. Such memory and processor(s) may also be implemented through one or more Integrated Circuits (ICs). An IC may be, for example, a microprocessor that accesses programming instructions or other data stored in a ROM and/or hardwired into the IC. For example, an IC may comprise an Application Specific Integrated Circuit (ASIC) having gates and/or other logic dedicated to the calculations and other operations described herein. An IC may perform some operations based on execution of programming instructions read from ROM or RAM, with other operations hardwired into gates or other logic. Further, an IC may be configured to output image data to a display buffer.

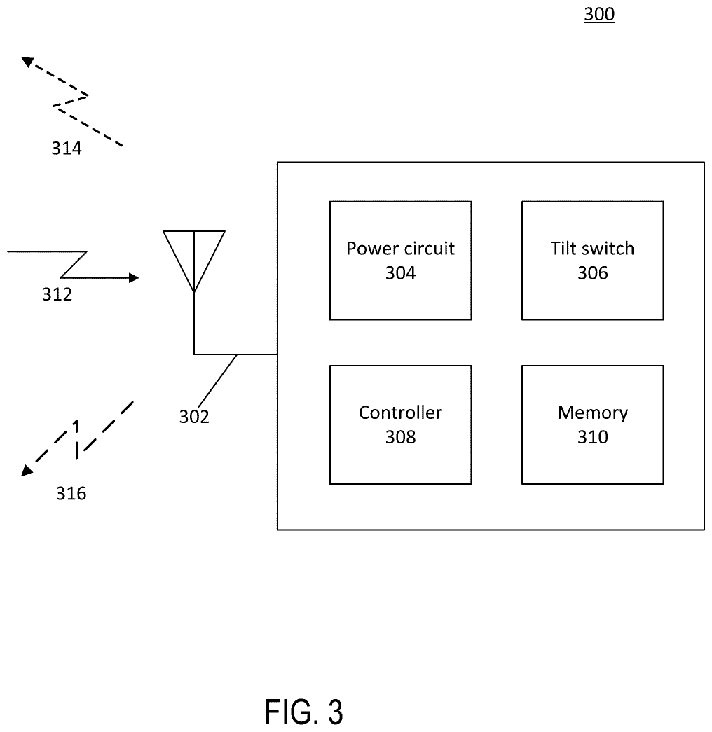

FIG. 3 shows an RFID tag 300 that may provide different data or information based on corresponding different orientations of the RFID tag 300. The RFID tag 300 may be an implementation of the RFID tag 160 depicted in FIG. 1. The RFID tag 300 may be considered to be an RFID chip. The RFID tag 300 may be any type of RFID tag including a passive RFID tag, an active RFID tag, or a semi-passive RFID tag. The RFID tag 300 may be attached or embedded in any device or component that is capable of varying its orientation. As an example, the RFID tag 300 may be attached to any type of card such as, but not limited to, a credit card, a debit card, or an identification (ID) card. As another example, the RFID tag may be embedded into a person (e.g., into a finger of a person's hand or into the back of a person's hand) or into a pet or other animal.

For purposes of discussion only, the RFID tag 300 is depicted in FIG. 3 as a passive RFID tag but is not so limited. The RFID tag 300 may comprise an antenna 302, a power circuit or component 304, a tilt switch or orientation sensor 306, a controller 308, and a memory component 310.

The antenna 302 may receive an RF signal from an RFID tag reader or interrogator (e.g., the RFID tag reader 150 depicted in FIG. 1; not shown in FIG. 3 for simplicity). The RF signal received by the antenna 302 from an RFID tag reader may be considered to be an interrogation signal or a scanning signal (or input RF signal). The antenna 302 may transmit an RF signal in response to a received RF signal from an RFID tag reader. The RF signal transmitted by the antenna 302 in response to an RF signal received from an RFID tag reader may be considered to be a backscattered RF signal (or output RF signal).

The RF signal transmitted by the antenna 302 may be a modulated signal. The modulated signal may convey data or information. The information conveyed by the modulated signal, and therefore the modulated signal itself, may vary based on an orientation of the RFID tag 300. For example, in response to an RF interrogation signal, the RFID tag 300 may transmit (or send) a first modulation signal conveying first information when the RFID tag 300 is in a first orientation and may transmit a second modulation signal conveying second information when the RFID tag 300 is in a second, different orientation. In an alternative, the RFID tag 300 may include a first antenna (e.g., the antenna 302) for receiving RF signals and a second antenna for transmitting RF signals.

The power circuit 304 may extract or harvest power from an RF signal received by the antenna 302. The power circuit 304 may comprise any combination of circuit elements or logic for generating power (e.g., DC power) from an RF signal received by the antenna 302. For example, the power circuit 304 may comprise a rectifier or other circuit elements such as, but not limited to, a diode and/or a capacitor. The power circuit 304 may provide power to any other component of the RFID tag 300 such as, for example, the controller 308 and/or the memory component 310.

The tilt switch 306 may be a switch or other logic or circuit component that is capable of sensing, detecting, and/or responding to different orientations of the RFID tag 300. As an example, the tilt switch 306 may be configured to sense a first orientation of the RFID tag 300 and may be configured to sense a second, different orientation of the RFID tag 300. Continuing with this example, the tilt switch 306 may be in a first state (e.g., may provide an open circuit) when the RFID tag 300 is in a first orientation and may be in a second state (e.g., may provide a closed circuit) when the RFID tag 300 is in a second orientation. As another example, the tilt switch 306 may be configured to be in a first state (e.g., may provide an open circuit) in all orientations of the RFID tag 300 other than a predetermined orientation of the RFID tag, in which the RFID tag may be in a second state (e.g., may provide a closed circuit).

The state of the tilt switch 306 may be detected or sensed by the controller 308. For example, the tilt switch 306 may provide a signal to the controller 308 that may be used by the controller 308 to determine a state of the tilt switch 306. As another example, the controller 308 may detect an orientation of the RFID tag 300 by detecting a state of the tilt switch 306-by detecting whether the tilt switch is providing a closed circuit or an open circuit. Overall, the controller 308 may be configured to determine an orientation of the RFID tag 300 based on a state of the tilt switch 306.

The controller 308 may be any type of controller including any type of microchip, processor, microcontroller, logic, or digital signal processor (DSP), or any combination thereof. The controller 308 may control operation of the RFID tag 300. The controller 308 may receive power from the power circuit 304. As an alternative, the RFID tag 300 may include a power source (e.g., a battery) that may supply power to the controller 308 alone or in conjunction with the power circuit 304.

As discussed above, the controller 308 may detect a state of the tilt switch 306 and therefore detect an orientation of the RFID tag 300. Any number of orientations of the RFID tag 300 may be detected by the controller 308 based on a corresponding number of states of the tilt switch 306. As an example, the controller 308 may detect whether the RFID tag 300 is positioned in a first orientation (e.g., based on the tilt switch providing an open circuit or a first signal) and may detect whether the RFID tag is positioned in a second orientation (e.g., based on the tilt switch providing a closed circuit or a second, different signal).

The controller 308 may be coupled to the memory component 310. The memory component 310 may comprise any number of memory components and may comprise any type of memory (e.g., any type of non-volatile memory). The memory component 310 may store one or more information signals, data, or information sequences, corresponding to one or more orientations of the RFID tag 300, that may be used to generate one or more corresponding output or backscattered RF signals.

As an example operation of the RFID tag 300, the controller 308 may read out different information sequences or signals stored in the memory component 310 based on a detected state of the tilt switch 306. For example, when the RFID tag is positioned in a first orientation, the tilt switch 306 may be in a first state, and a first information sequence may be read out from the memory component 310. The first information sequence may comprise binary data. The first information sequence may be used to modulate a received RF signal 312 to generate a first output or backscattered RF signal 314. The first output RF signal 314 may convey any first information (e.g., a first ID, a first command, a first request, etc.).

When the RFID tag 300 is positioned in a second orientation, the tilt switch 306 may be in a second state, and a second information sequence may be read out from the memory component 310. The second information sequence may be used to modulate the received RF signal 312 to generate a second output or backscattered RF signal 316. The second output RF signal may convey any second information (e.g., a second ID, a second command, a second request, etc.). As an alternative, the RFID tag 300 may be configured to transmit an output RF signal when the RFID tag 300 is in a predetermined orientation and not to transmit any RF signal when the RFID tag 300 is in any other orientation (or may transmit null data). Accordingly, the RFID tag 300 may transmit a first output RF (e.g., the first output RF signal 314) when the RFID tag 300 is in a first specific orientation or is oriented within a first range of orientations (e.g., corresponding to a first state of an orientation sensor), and the RFID tag 300 may transmit a second output RF (e.g., the second output RF signal 3146) when the RFID tag 300 is in a second specific orientation or is oriented within a second range of orientations (e.g., corresponding to a second state of an orientation sensor).

The controller 308 may control modulation of any output RF signal based on any information sequence stored by the memory component 310. The controller 308 may modulate any output RF signal according to any modulation scheme or technique including, but not limited to amplitude-shift keying (ASK), phase-shift keying (PSK), on-off keying (OOK), etc.

As shown in FIG. 3, the first output RF signal 314 may be transmitted in response to the received RF signal 312, which may be considered an interrogation signal that is transmitted by an RFID tag reader. As additionally shown in FIG. 3, the second output RF signal 316 may be transmitted in response to the received RF signal 312. As an alternative, the RFID tag 300 may transmit the first output RF signal 314 when the RFID tag 300 is in a predetermined orientation and may not transmit any RF signal when the RFID tag 300 is in any other orientation (e.g., such that the second RF output signal 316 is not transmitted).

Also, or alternatively, one of a plurality of output RF signals may be provided based on a plurality of corresponding orientations of the RFID tag 300, as sensed by the tilt switch 306. For example, the tilt switch 306 may be capable of detecting N different orientations of the RFID tag 300 and the memory component 310 may store N corresponding different information sequences (e.g., where N is an integer). Based on the tilt switch 306 detecting one of the N different orientations of the RFID tag 300, the controller 308 may read out one of the N different information sequences stored by the memory component 310 that corresponds to the detected orientation of the RFID tag 300. The controller 308 may then cause the antenna 302 to transmit one of N different output RF signals based on the determined information sequence. In this manner, any number of different output RF signals may be transmitted by the RFID tag 300 based on a corresponding number of different orientations of the RFID tag 300 being sensed by the tilt switch 306, thereby allowing the RFID tag 300 to provide or convey any number of different IDs, commands, requests, etc. A single tilt switch may be configured to detect N different orientations to the RFID tag 300 or any number of tilt switches may be used together to detect the N different orientations to the RFID tag 300.

Any RF output signal transmitted by the RFID tag 300 may be modulated by shunting the antenna 302, by varying any properties of the antenna 302, and/or by varying any properties of any circuit or circuit element of the RFID tag 300 that may be associated with transmitting an RF output signal. As an example, the orientation of the RFID tag 300 may cause the tilt switch 306 to add or remove various different circuit elements that may be associated with transmitting an RF output signal, thereby allowing properties of the RF output signal to varying based on the properties of the circuit elements added or removed. In general, any modulation technique implemented by RFID tags may be used by the RFID tag 300.

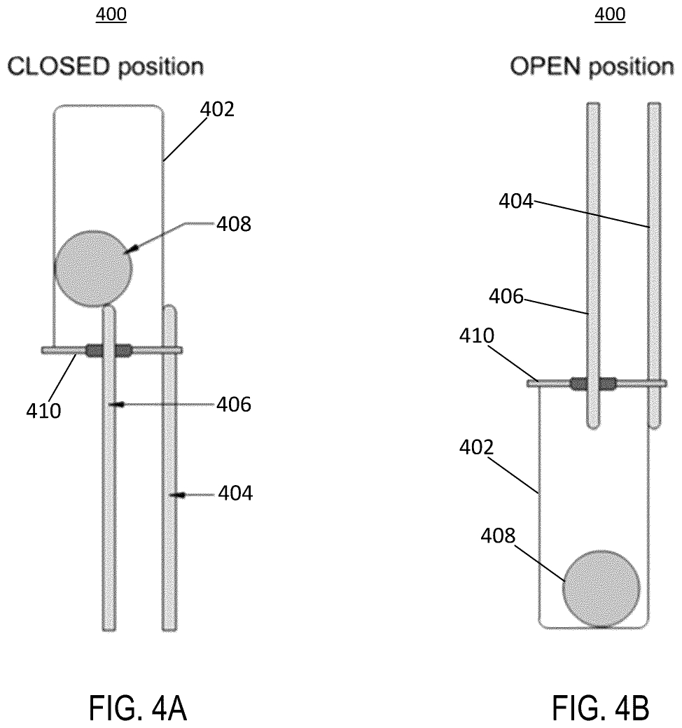

FIG. 4A shows an example tilt switch 400 in a first position. The tilt switch 400 may be an implementation of the tilt switch 306. The first position of the tilt switch 400 depicted in FIG. 4A may correspond to a closed state or a first state of the tilt switch 400.

The tilt switch 400 may comprise a case 402, an outer pin or connector 404, a central pin or connector 406, a ball bearing 408, and a frame 410. The case 402 may comprise a conductive material such as metal. The case 402 may house the ball bearing 408 within an inner (open) region of the case 402. The ball bearing 408 may also comprise a conductive material such as metal. The inner (open) region of the case 402 may be filled with a non-conductive liquid (e.g., an oil) to dampen/slow movement of the ball bearing 408 (e.g., to prevent rattling).

The case 402 may be supported by the frame 410 (e.g., connected or attached to the frame 410). The frame 410 may comprise a non-conductive material. The central pin 406 may be supported by and may extend through the frame 410 and into the inner region of the case 402 that houses the ball bearing 408. As shown in FIG. 4A, the central pin 406 may be positioned centrally with respect to the frame 410 and the case 402. The outer pin 404 may also be supported by the frame 410 and may be positioned peripherally with respect to the frame 410. The outer pin 404 may be connected to an outer portion of the case 402. The outer pin 404 and the central pin 406 may both comprise a conductive material such as metal. The central pin 406 may be electrically insulated from the case 402. The outer pin 404 may be electrically connected to the case 402.

The tilt switch 400 may operate by detecting or sensing a roll or movement of the ball bearing 408 within the case 402. The ball bearing 408 may be allowed to move or roll around within the inner region of the case 402—for example, as an RFID tag containing the tilt switch 400 is moved. Based on a position or tilt of the tilt switch 400, the ball bearing 408 may at times contact central pin 406. As shown in FIG. 4A, when the ball bearing 408 contacts the central pin 406, the central pin 406, the ball bearing 408, the case 402, and the outer pin 404 may together be electrically connected, thereby completing (or closing) a circuit that may indicate or represent the tilt switch 400 being in a closed position (or a first position/first state). The electrical connectivity between the central pin 406, the ball bearing 408, the case 402, and the outer pin 404 as depicted in FIG. 4A may be detected or sensed by a controller (e.g., the controller 308) of an RFID tag (e.g., the RFID tag 300).

FIG. 4B shows the tilt switch 400 in a second position. The second position of the tilt switch 400 depicted in FIG. 4B may correspond to an open state or a second state of the tilt switch 400. As shown in FIG. 4B, the ball bearing 408 may no longer contact the central pin 406. As a result, the central pin 406, the ball bearing 408, the case 402, and the outer pin 404 may no longer be electrically connected together, thereby not completing (or opening) a circuit that may indicate or represent the tilt switch 400 being in an open position (or a second position/second state). The lack of electrical connectivity between the central pin 406, the ball bearing 408, the case 402, and the outer pin 404 as depicted in FIG. 4B may be detected or sensed by a controller (e.g., the controller 308) of an RFID tag (e.g., the RFID tag 300).

As described above, whether the ball bearing 408 contacts the central pin 406 or not—and therefore completes a circuit or not, respectively—may be detected by the controller 308. As explained herein, when the controller 308 detects that the tilt switch 400 is in a closed position (e.g., as shown in FIG. 4A), the controller 308 may cause the RFID tag 300 to transmit a first RF output signal. When the controller 308 detects that the tilt switch 400 is in an open position (e.g., as shown in FIG. 4B), the controller 308 may cause the RFID tag 300 to transmit a second RF output signal. Each RF output signal may then be received and processed to determine what information was conveyed (e.g., which ID, which command, which request, etc.).

The tilt switch 306 is not limited to the implementation of the tilt switch 400 shown in FIGS. 4A and 4B. Any type of tilt switch that is capable of sensing one or more different positions or orientations may be used by the RFID tag 300. For example, a tilt switch (e.g., the tilt switch 400) may include multiple pins positioned at various angles that may come into contact with a moveable conductive member (e.g., the ball bearing 408) when the tilt switch is held in different positions, thereby enabling the tilt switch to sense various orientations (i.e., more than two orientations). Further, multiple different tilt switches may be used in combination—for example, positioned at various orientations and/or including various pins arranged in various orientations—to detect multiple different orientations of an RFID tag. As another example, a tilt switch may include a liquid conductive material (e.g., mercury) in lieu of a solid conductive member (e.g., instead of the ball bearing 408) that may be capable of contacting differently oriented pins arranged in an open inner region (e.g., the inner region of the case 402) of the tilt switch, thereby allowing multiple different orientations to be detected. Accordingly, one or more tilt switches may be arranged and communicatively coupled so as to be able to detect three or more distinct orientations.

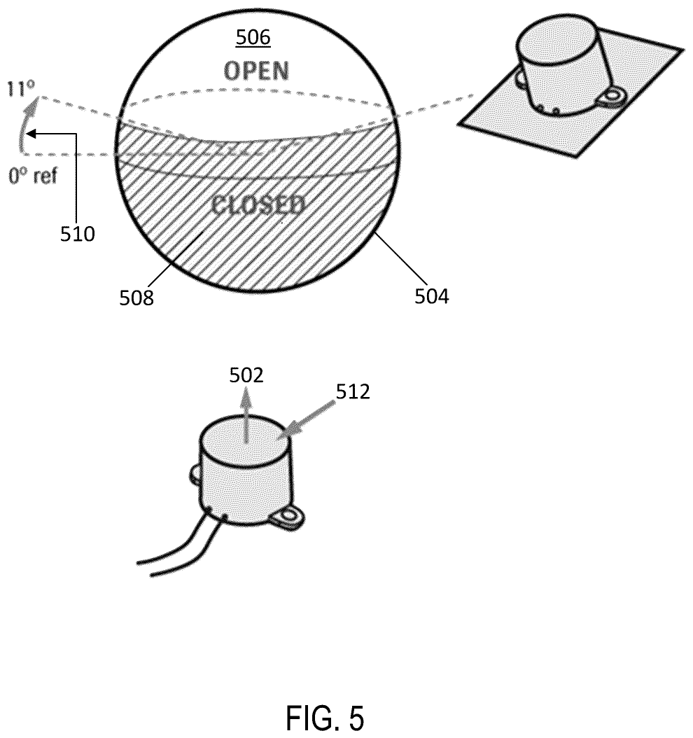

FIG. 5 shows an example range of orientations of an example tilt switch 512 when in a closed position (e.g., a first state) and when in an open position (e.g., a second state). The tilt switch 512 may provide similar functionality as the tilt switch 400 in that it may detect two different orientation states. FIG. 5 includes a reference indicator 502 and a reference orientation sphere 504. The reference indicator 502 may be perpendicular to a top outer surface of the tilt switch 512. The reference orientation sphere 504 may indicate a range of different positions or orientations of the tilt switch 512 relative to the reference indicator 502. Over a first range of orientations 506 (e.g., relative to a direction the reference indicator 502 is pointing), the tilt switch 512 may be in the open position. Over a second range of orientations 508 (e.g., relative to a direction the reference indicator 502 is pointing), the tilt switch 512 may be in the closed position. When the reference indicator 502 is pointing directly upwards (e.g., relative to a zero-degree reference of the reference orientation sphere 504), a state of the tilt switch 512 may be similar to the orientation of the tilt switch 400 as shown in FIG. 4B. When the reference indicator is pointing directly downwards (e.g., relative to the zero-degree reference of the reference orientation sphere 504), a state of the tilt switch 400 may be similar to the orientation of the tilt switch 400 as shown in FIG. 4A.

As an example operation of the tilt switch 512, the tilt switch 512 may initially be in a closed position. As the tilt switch 512 is moved or tilted, the tilt switch 512 may progress to an open position. A tilt angle 510 may indicate an amount of movement or tilt of the tilt switch 512 that may cause the tilt switch 512 to switch from the closed position to the open position. The tilt angle 510 may correspond to an angle of the reference indicator 502 relative to a top of the tilt switch 512 when the tilt switch 512 is orientated such that the reference indicator 502 is pointing directly upwards (e.g., relative to a plane perpendicular to the reference indicator 502 when it is pointing directly upwards). The tilt angle 510 provides some tolerance for allowing the tilt switch 512 to remain in a closed state before transitioning to an open state (e.g., such that the tile switch 512 does not need to be held exactly right side up to remain in the closed state). As described herein, the tilt switch 512 may be configured to transmit a first RF output signal when oriented in any position within the first range of orientations 506 and to transmit a second RF output signal when oriented in any position within the second range of orientations 508. The tilt switch 512 may be used in combination with, or instead of, any other orientation sensor described herein including, for example, the tilt switch 400.

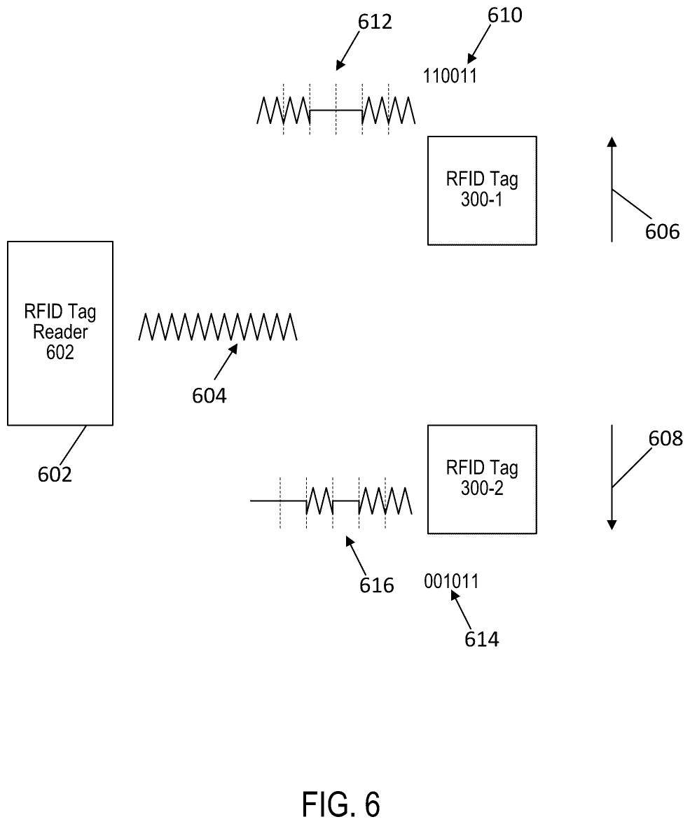

FIG. 6 shows different output signals that may be provided by the RFID tag 300 based on different corresponding orientations of the RFID tag 300. FIG. 6 includes an RFID tag reader or integrator 602, an RFID tag 300-1 in a first orientation, and an RFID tag 300-2 in a second orientation. The RFID tags 300-1 and 300-2 may represent the RFID tag 300 in different orientations. The RFID tag reader 602 may represent an implementation of the RFID tag reader 150 depicted in FIG. 1.

The RFID tag reader 602 may transmit a signal 604. The signal 604 may be an RF signal and may be considered to be an interrogation or scanning signal. As an example, the signal 604 may be a continuous waveform. Reference indicator 606 may indicate an orientation of the RFID tag 300-1. For example, the reference indicator 606 may indicate that the RFID tag 300-1 is in a first orientation that may correspond to an open position of the tilt switch 306. Reference indicator 608 may indicate an orientation of the RFID tag 300-2. For example, the reference indicator 608 may indicate that the RFID tag 300-2 is in a second orientation that may correspond to a closed position of the tilt switch 306.

The RFID tag 300-1, oriented in the first position, may receive the signal 604. Reception of the signal 604 may cause the RFID tag 300-1 to read out a first information sequence 610 from the memory 310. As an example, the first information sequence 610 may be a binary sequence such as 110011. Reception of the signal 604 may further cause the RFID tag 300-1 to output signal 612 based on the first information sequence 610 and the signal 604. For example, the output signal 612 may be a backscattered modulated signal that is a modulated version of the signal 604. The output signal 612 may comprise a version of the signal 604 (e.g., a reflected and/or attenuated version of the signal 604) modulated by the first information sequence 610. The modulated output signal 612 may convey first information from the RFID tag 300-1 to the RFID tag reader 602. The RFID tag reader 602 may interpret this first information, for example, as a first command or a first ID.

The RFID tag 300-2, oriented in the second position, may also receive the signal 604. Reception of the signal 602 may cause the RFID tag 300-2 to read out a second information sequence 614 from the memory 310. As an example, the second information sequence 614 may be a binary sequence such as 001011. Reception of the signal 604 may further cause the RFID tag 300-2 to output signal 616 based on the second information sequence 614 and the signal 604. For example, the output signal 616 may be a backscattered modulated signal that is a modulated version of the signal 604. The output signal 616 may comprise a version of the signal 604 (e.g., a reflected and/or attenuated version of the signal 604) modulated by the second information sequence 614. The modulated output signal 616 may convey second information from the RFID tag 300-2 to the RFID reader 602. The RFID reader 602 may interpret this second information, for example, as a second command or a second ID.

In this manner, different orientations of the RFID tag 300, as detected by the tilt switch 306, may cause the RFID tag 300 to transmit different RF signals to the RFID tag reader 602 based on a signal 604 initially transmitted by the RFID tag reader 602. By transmitting different RF signals to the RFID tag reader 602 based on corresponding different orientations of the RFID tag 300, the RFID tag 300 may provide different information to the RFID tag reader 602 based on the orientation of the RFID tag 300 (e.g., at the time of receiving and/or processing the signal 604). This enables any type of command or ID, or any type of sequence of commands or IDs, to be conveyed to the RFID tag reader 602 by the RFID tag 300. In turn, as explained in more detail below, the RFID tag reader 602 may interpret the received commands and/or IDs from the RFID tag 300 to facilitate performance of any function such as, for example, authorize a transaction or identify an individual. Overall, the RFID tag 300 enables different information to be provided by the RFID tag 300 based on its orientation, and the different information that may be provided by the RFID tag 300 may be used by the RFID tag reader 602 to trigger performance of any function.

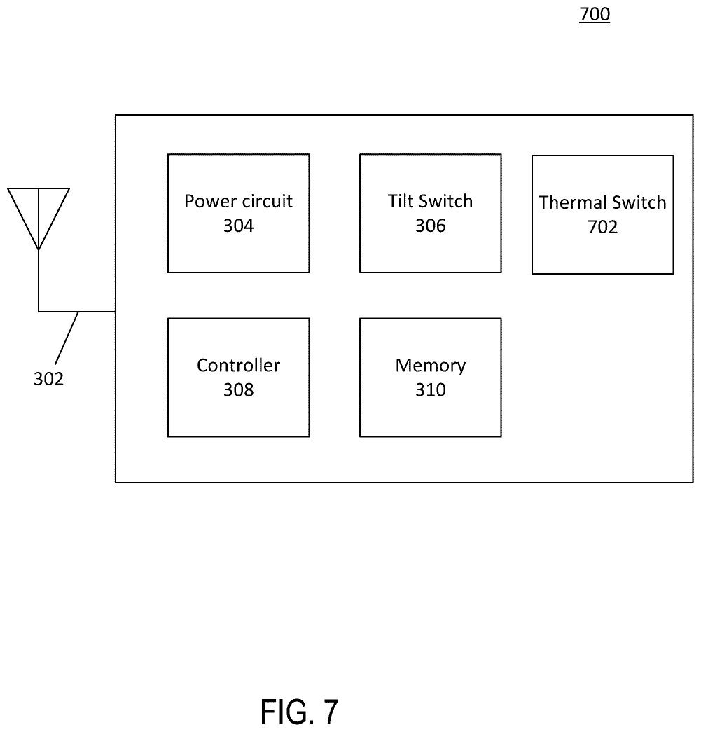

FIG. 7 shows an RFID tag 700 that may provide different information based on corresponding different orientations of the RFID tag 700 that may also include various additional feature detection switches. The RFID tag 700 may include various components that are similar to or the same as the components of the RFID tag 300. The RFID tag 700 may also operate in a similar or the same manner as the RFID tag 300 as described herein. The RFID tag 700 may be an implementation of the RFID tag 160 depicted in FIG. 1.

FIG. 7 shows that the RFID tag 700 may additionally include a temperature detection switch 702. The temperature detection switch 702 may include any type of thermal detection component capable of changing states (e.g., from a first state to a second state) based on a detected temperature. For example, the temperature detection switch 702 may be in an open state (e.g., a first state) when the temperature detection switch 702 detects a temperature that satisfies a predetermined temperature threshold (e.g., when the detected temperature meets or exceeds the predetermined temperature threshold). As a further example, the temperature detection switch 702 may be in an open state (e.g., a first state) when the temperature detection switch 702 detects a temperature that exceeds 90 degrees Fahrenheit.

The temperature detection switch 702 may be in a closed state (e.g., a second state) when the temperature detection switch 702 detects a temperature that does not satisfy a predetermined temperature threshold (e.g., when the detected temperature does not meet or exceed the predetermined temperature threshold). As a further example, the temperature detection switch 702 may be in a closed state (e.g., a second state) when the temperature detection switch 702 detects a temperature that is below 90 degrees Fahrenheit.

The state of the temperature detection switch 702 may be indicated by the RFID tag 700 to an RFID tag reader (e.g., the RFID tag reader 150 depicted in FIG. 1). As an example, the state of the temperature detection switch 702 may change which information sequence is read from the memory 310 and used to modulate a transmitted RF output signal by the RFID tag 700. By doing so, the RFID tag 700 may provide information indicating a detected temperature in relation to the predetermined temperature threshold. For example, when the temperature detection switch 702 detects a first temperature associated with the RFID tag 700 that is less than a predetermined temperature threshold, the RFID tag 700 may transmit a first RF output signal based on a first stored information sequence when the RFID tag 700 is in a first orientation. When the temperature detection switch 702 detects a second temperature associated with the RFID tag 700 that is greater than the predetermined temperature threshold, the RFID tag 700 may transmit a second RF output signal based on a second stored information sequence when the RFID tag 700 is in the first orientation. Accordingly, the RFID tag 700 may transmit different signals and may convey different information (e.g., different information about a detected temperature associated with the RFID tag 700) when the RFID tag is in the same orientation but is associated with a different detected temperature.

The detected temperature may be any temperature of any device or thing. For example, the RFID tag 700 may be embedded in a human and may indicate, based on the state of the RFID tag, whether the RFID tag 700 is embedded in a person or has been removed from the person. If the RFID tag 700 indicates that it has been removed from the person (e.g., because a temperature threshold is not met), then certain RF output signals that may be transmitted by the RFID tag 700 may no longer be valid, or may no longer even be capable of being transmitted. This may prevent an RF output signal from being transmitted that may otherwise indicate authorization for a command or operation (e.g., for a financial transaction), thereby providing enhanced authorization security.

The temperature detection switch 702 may be capable of transitioning between different states based on a repeated comparison of a detected temperature to a predetermined temperature threshold, or the temperature detection switch 702 may transition from a first state to a second state permanently once a certain predetermined temperature threshold is crossed. The RFID tag 700 may include any other types of environmental detection switches or components that may change or alter information that may be provided by the RFID tag 700 based on a state of any environmental detection switch. As an example, the RFID tag 700 may include a shock detection switch (which may be considered to be a shock sensor switch). A shock detection switch may permanently switch from a first state to a second state when a shock or force of a certain amount is absorbed by the RFID tag 700 (or a device or component connected or in close proximity to the RFID tag 700). For example, the RFID tag 700 may be connected to a television. A shock detection switch of the RFID tag 700 may absorb a force when the television is dropped during shipping. As a result, the shock detection switch may permanently switch from a first state (e.g., an open state) to a second state (e.g., a closed state) to indicate that a force that satisfies a predetermined force threshold has been absorbed. As explained above, the state of the shock detection switch may influence the information provided by the RFID tag 700 such that an indication of the absorbed force may be conveyed to an RFID tag reader. Any type of environmental detection switch may be included in the RFID tag 700, with each environmental detection switch capable of operating within any number of states to thereby alter any information provided by the RFID tag 700 in any number of corresponding manners. Other detection switches or sensors may be included within RFID tag 700 such as, for example, switches or sensors that detect humidity, magnetic flux, or gas, and the RFID tag 700 may provide different data for a given orientation based on a state of any additional switch or sensor.

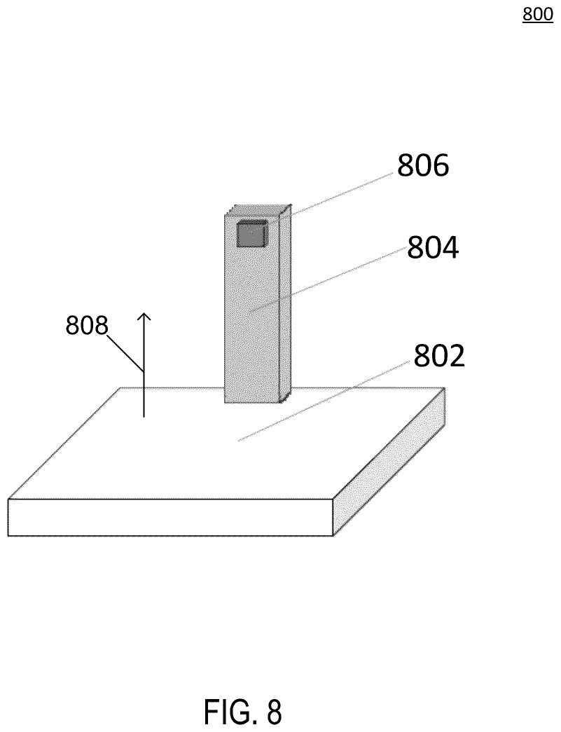

FIG. 8 shows an RFID tag reader 800. The RFID tag reader 800 may be an implementation of the RFID tag reader 150 depicted in FIG. 1. The RFID tag reader 800 may comprise a lower portion or pad 802, a stand 804, and a magnet 806. The pad 802 may contain components to enable the RFID tag reader 800 to transmit an RF output signal (e.g., an RFID tag interrogation signal) and to receive an RF input signal (e.g., an RF signal outputted by an RFID tag). As an example, a person's finger may contain an embedded RFID tag (e.g., the RFID tag 300 or the RFID tag 700). The person may position the person's hand over the pad 802 in order for the embedded RFID tag to be interrogated or read by the RFID reader 800. An open area over the pad 802 enables the person to orient the person's hand in various positions to cause the embedded RFID tag to transmit any number of RF output signals, based on the person's hand orientation (and therefore orientation of the embedded RFID tag).

The RFID tag reader 800 may be configured to receive any waveform transmitted by an RFID tag. The RFID tag reader 800 may be configured to process any waveform or series of waveforms to receive any information (e.g., a code, an ID, a command, etc.) intended to be conveyed via any waveform or series of waveforms transmitted by an RFID tag read by the RFID tag reader 800. The RFID tag reader 800 may store and/or transmit any such received information to any other computing device that may be coupled to the RFID tag reader 800 (e.g., any other device or component depicted in FIG. 1).

The stand 804 may be connected to the pad 802. The stand 804 may house the magnet 806. The magnet 806 may be selectively activated to invoke a certain state of a tilt switch contained with an RFID tag (e.g., the tilt switch 306). As an example, the magnet 806 may typically or usually be deactivated such that it does not influence the operation of a tilt switch contained within an RFID tag (e.g., the RFID tag 300 or the RFID tag 700). However, at times it may be desirable to activate the magnet 806 to attract a metal component of a tilt switch (e.g., the ball bearing 408). As a result, the metal component of the tilt switch may be attracted upwards towards the magnet 806 relative to the pad 802, as indicated by direction indicator 808 (e.g., in a direction orthogonal to a plane of the pad 802). In doing so, the RFID tag reader 800 may cause the tilt switch to transition to a certain state (e.g., an open or closed state) based on a movement of the metal component of the tilt switch.

The RFID tag reader 800 may comprise a user interface (not depicted in FIG. 8 for simplicity) allowing a user to control operation of the RFID tag reader 800. The RFID tag reader 800 may be coupled to a network and may be coupled to one or more other computing devices including, but not limited to, a remote computing device or database, as described above in relation to FIG. 1.

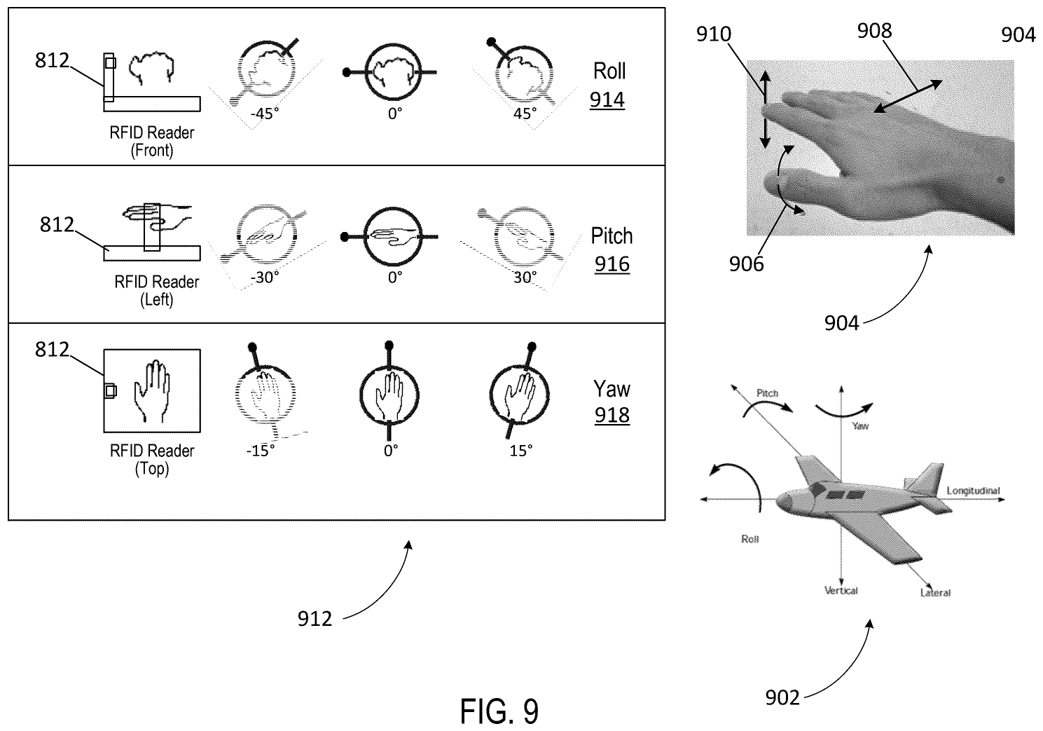

FIG. 9 shows example hand orientations that may correspond to different orientations of an RFID tag (e.g., the RFID tag 300 or the RFID tag 700) that may be embedded in a person's hand or finger. For purposes of discussion only, FIG. 9 includes a first reference diagram 902 that shows three reference axes indicating different movements that are possible when an object (e.g., an airplane) moves within a space or medium (e.g., a three-dimensional space). Specifically, the first reference diagram 902 shows a first movement—roll—that may occur about a reference longitudinal axis, a second movement—yaw—that may occur about a reference vertical axis, and a third movement—pitch—that may occur about a reference lateral axis, relative to the orientation of the object shown.

As with the object shown in the first reference diagram 902, a second reference diagram 904 of FIG. 9 shows the three different movements that are possible for a person's hand relative to the reference axes. As shown in the second reference diagram 904, a roll indicator 906, a yaw indicator 908, and a pitch indicator 910 show the various manners the person's hand may move or rotate relative to three axes of movement.

In view of the first reference diagram 902 and the second reference diagram 904, FIG. 9 further shows a third reference diagram 912. The third reference diagram 902 shows the movement of a person's hand as it may be rotated about the three different reference axes relative to the RFID tag reader 802. Specifically, a top portion (top row) 914 of the third reference diagram 912 shows how the roll of a person's hand may be varied with respect to the RFID tag reader 802. The middle portion (middle row) 916 of the third reference diagram 912 shows how the pitch of a person's hand may be varied with respect to the RFID tag reader 802. The lower portion (lower row) 918 of the third reference diagram 912 shows how the yaw of a person's hand may be varied with respect to the RFID tag reader 802.

When embedded in a person's hand, an RFID tag (e.g., the RFID tag 300 or the RFID tag 700) may be configured to transmit a particular RF output signal based a corresponding roll, pitch, and yaw orientation. Based on the particular roll, pitch, and yaw of the person's hand, corresponding information may be provided to the RFID tag reader 800. In this manner, various different roll, pitch, and yaw orientations of the person's hand may enable a person to issue various commands or provide various data to an RFID tag reader.

As an example, a specific combination of roll, pitch, and yaw orientations of a person's hand may cause an embedded RFID tag to transmit a code specific to the person (e.g., an authorization code or ID code), while all other orientations of the person's hand may not cause the embedded RFID tag to transmit the code specific to the person (e.g., a false code may be transmitted or no transmission may be made). This technique may prevent an eavesdropper from stealing the person's code passively without the person's knowledge. That is, an eavesdropper armed with an RFID tag reader would not be able to read the code from the RFID tag embedded in the person's hand unless the person were to position the person's hand in a specific orientation that allows the code to be read.

The orientations shown and described in relation to FIG. 9 are not limited to RFID tags embedded within a person's hand and may also or alternatively be used to determine what information is provided by an RFID tag that is provided in conjunction with any item such as, for example, a card (e.g., a credit card or ID card) that may contain an RFID tag as described herein.

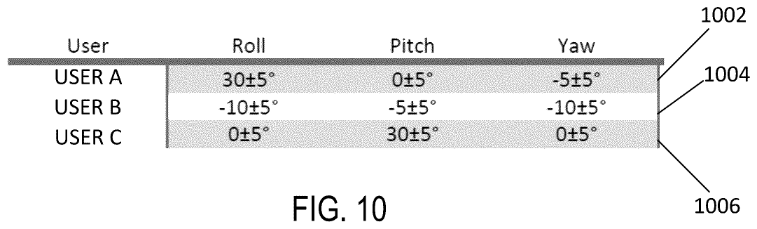

FIG. 10 shows various example user RFID activation orientations. The RFID activation orientations may relate to different users (e.g., Users A, B, and C) that each have an RFID tag (e.g., the RFID tag 300 or the RFID tag reader 800) embedded within their hands. Each embedded RFID tag may be associated with a unique code or ID for the users that may be used to provide an authorized command or instruction (e.g., to authorize a financial transaction).

As shown, a first orientation 1002 is associated with User A, a second orientation 1004 is associated with User B, and a third orientation 1006 is associated with User C. As a specific example, when User A positions User's A hand in an orientation corresponding to a roll of 30±5°, a pitch of 0±5°, and a yaw of −5±5°, the RFID tag embedded in User A's hand may be configured to transmit an RF output signal that provides a code, activation signal, or other information intended to convey an authorized command, instruction, or other data to an RFID tag reader. As shown, the first orientation 1002 for User A allows for some slight variation in the orientation by allowing for a five-degree variance in each direction of movement (indicated by the “±5°” shown in the table).

The orientations shown in FIG. 10 may be considered to be active orientations because the orientations may cause a valid or authorized data signal to be provided by the RFID tag. In all other orientations, for example, the RFID tag may not provide the valid or authorized data signal (e.g., no data signal may be provided or a dummy data signal may be provided). By designating an activate orientation for a user, the user may be assured that the RFID tag is only providing sensitive data (e.g., the valid or authorized data signal) when the user specifically positions the user's hand in a certain manner. In doing so, the likelihood that the RFID tag provides sensitive data at other times (e.g., when a user is holding the user's hand in another orientation such as when walking) is reduced, thereby preventing a bad actor from attempting to read sensitive data from the RFID tag without the user's knowledge. Active orientations may be customized to a user. Further, the activate orientations as described in relation to FIG. 10 are not limited to embedded RFID tags but are applicable to any device (e.g., a card) that contains or is connected to an RFID tag.

As described herein, different orientations of an embedded RFID tag may cause different corresponding data or codes to be transmitted. As such, a user with an embedded tag may be able to output various different data sequences that correspondingly cause different actions to occur based on a particular sequence of orientations of the user's hand. For example, an embedded RFID tag of a user may output a first code when the user holds his hand in a first orientation, may output a second code when the user holds his hand in a second orientation, and may output a third code when the user holds his hand in a third orientation. This may allow the user to issue a first command to cause a first action to occur when the user holds his hand in a first sequence of orientations—for example, a sequence of orientations that include the first orientation, the third orientation, and then the first orientation again such that the first code, the third code, and then first code again are provided in sequence. Further, a second command to cause a second action to occur may be issued in response to the user holding his hand in a second, different sequence of orientations—for example, a sequence of orientations that include the first orientation, the third orientation, and the second orientation such that the first code, the third code, and the second code are provided in sequence.

The table below summarizes various example use cases involving an RFID tag as described herein (e.g., the RFID tag 300 or the RFID tag reader 800). For use case no. 1, using an RFID tag as described herein to authorize a financial transaction may reduce risks associated with financial accounts as a bad actor would be unable to conduct fraudulent financial activity without access to and knowledge of a user's particular RFID orientation that results in authorization of a transaction. For use case no. 2, using an RFID tag as described herein to secure personal property (e.g., a bike, a car, etc.) may reduce the likelihood that such property is stolen as a bad actor would be unable to unlock or access the personal property without access to and knowledge of a user's particular RFID orientation that results in granting access to the property (e.g., unlocking a car door, unlocking a chain lock, etc.). For use case no. 3, using an RFID tag as described herein to provide an emergency alert may allow a user to either openly or covertly communicate an indication of an alarm condition to any remote system or individual. For example, a user may hold the RFID tag in a specific orientation that indicates that the user is in immediate danger and the RFID tag reader may provide that information to appropriate emergency response individuals and systems (e.g., the police). For use case no. 4, using an RFID tag as described herein to activate or deactivate a car based on the RFID tag being positioned close to a certain area of the car (e.g., the steering wheel) and/or in a specific orientation may prevent carjacking. For use case no. 5, using an RFID tag as described herein to control a device may allow for intuitive or fast responding control of the device. Any type of device may be controlled by the user. As an example, one or more RFID tags may be embedded in one or more fingers of a user, and certain orientations of the user's fingers may cause certain control of a device. The device may be caused to move or to operate in a certain manner based on the user's commands.

TABLE 1
Example RFID tag use case scenarios

| Use | | |
|---|---|---|
| Case | | |
| No. | Use Case | Example Scenario |
| 1 | MFA of a financial | Point of sale (POS) device may include an RFID tag |
| | transaction. | reader. User may use a financial card (e.g., a credit |
| | | card) to finance a transaction. User may then use an |
| | | RFID tag held in a specific orientation to authorize the |
| | | transaction. If the RFID tag is not held in the correct |
| | | orientation, then the transaction will not be authorized. |
| 2 | Preventing theft of | A car may include an RFID tag reader and may be |
| | personal property. | unlocked if the user's RFID tag is held in a specific |
| | | orientation (possibly in combination with using a key). |
| | | If the RFID tag is not held in the correct orientation, |
| | | then the car will not unlock. |
| 3 | Emergency alert | RFID tag may be positioned into a specific orientation |
| | (audible or silent) | to provide an alert to an RFID tag reader. Any type of |
| | | alert may be provided (e.g., indicating that someone is |
| | | attempting to steal an RFID tag, that someone is in |
| | | imminent physical danger, etc.). RFID tag reader may |
| | | route the alert to appropriate responding systems. |
| 4 | Preventing carjacking. | An interior of a car may include an RFID tag reader. |
| | | The car may be activated only if the user's RFID tag |
| | | is held in a specific orientation. |
| | | A user's car may stop working if the user's RFID tag |
| | | is not positioned close to the car's steering wheel for a |
| | | specified period of time. |
| 5 | Control of a device | A user may issue commands/instructions for |
| | (e.g., a fighter jet). | controlling a device based on specific orientations of |
| | | an embedded RFID tag. For example, a user may |
| | | control a fighter jet to turn or to fire a weapon. The |
| | | device to be controlled may include an RFID tag |
| | | reader that responds or causes certain actions in |
| | | response to different commands received from one or |
| | | more RFID tags. |

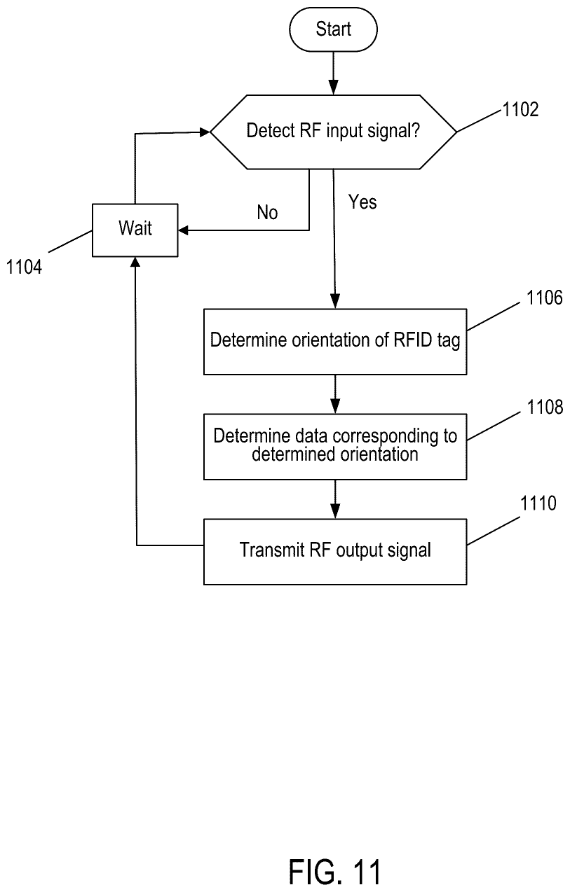

FIG. 11 is a flow chart showing steps of an example method of an RFID tag providing data based on an orientation of the RFID tag. One, some, or all steps of the example method of FIG. 11 may be performed by any of the devices described herein (e.g., RFID tag 300 or the RFID tag reader 800). Also or alternatively, one, some, or all steps of the example method of FIG. 11 may be performed by one or more other devices, including any of the computing devices described herein. Steps of the example method of FIG. 11 may be omitted, performed in other orders, and/or otherwise modified, and/or one or more additional steps may be added.

The method may start in step 1102. In step 1102, an RFID tag may detect whether the RFID tag is receiving an RF input signal. The RF input signal may be a scanning signal or an interrogation signal transmitted by an RFID tag reader.

If the RFID tag is not receiving an input RF signal, step 1104 may be performed. In step 1104, the RFID tag may wait until an input RF signal is received and may repeat step 1102 as shown.

If the RFID tag detects reception of an input RF signal, step 1106 may be performed. In step 1106, an orientation of the RFID tag may be determined. The orientation of the RFID tag may be determined using an orientation sensor (e.g., the tilt switch 306).

In step 1108, based on the determined orientation of the RFID tag, the RFID tag may determine data or other information (e.g., a unique ID, a bit sequence, etc.) to provide in response to the input RF signal. The data may be stored in a memory of the RFID tag (e.g., the memory component 310).

In step 1110, the RFID tag may transmit an output RF signal. The output RF signal may be a backscattered signal based on the input RF signal. The output RF signal may provide the data determined in step 1108. For example, the output RF signal may be modulated based on the data determined in step 1108. After step 1110, step 1102 may be performed—for example, via wait step 1104—and the RFID tag may await another input RF signal.

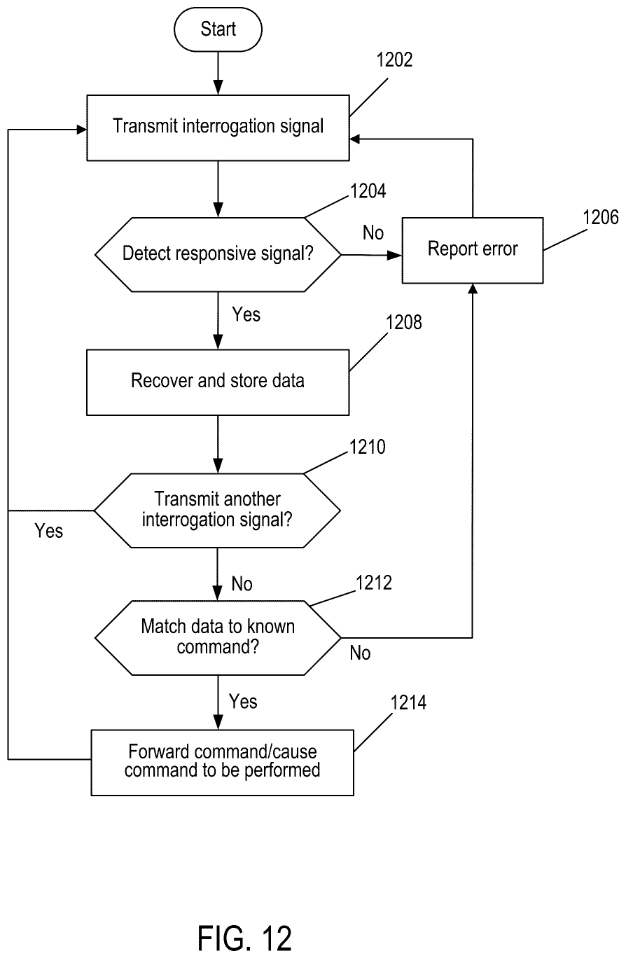

FIG. 12 is a flow chart showing steps of an example method of an RFID tag reader receiving data from an RFID tag based on the orientation of the RFID tag. One, some, or all steps of the example method of FIG. 12 may be performed by any of the devices described herein (e.g., RFID tag reader 802). Also or alternatively, one, some, or all steps of the example method of FIG. 11 may be performed by one or more other devices, including any of the computing devices described herein. Steps of the example method of FIG. 12 may be omitted, performed in other orders, and/or otherwise modified, and/or one or more additional steps may be added.

The method of FIG. 12 may be implemented by an RFID tag reader to receive a sequence of data from an RFID tag. For example, the method of FIG. 12 may be implemented when the RFID tag reader may provide one or more interrogation signals to the RFID tag. In response, the RFID tag may provide one or more responsive signals, with each signal providing different data based on the orientation of the RFID tag. In this manner, the RFID tag may send first data in response to a first interrogation signal from the RFID tag reader and may send second data in response to a second interrogation signal from the RFID tag reader. The RFID tag may change orientations between receiving the two different interrogation signals such that the RFID tag provides different data in response to each interrogation signal. The RFID tag reader may receive the first data and the second data and may determine if a valid command or instruction corresponds to the first data and the second data (e.g., in combination). As an alternative to transmitting one or more interrogation signals, the RFID tag reader may provide a single interrogation signal for a longer period of time, allowing the RFID tag to change orientations while receiving the interrogation signal so that the data provided in response to the interrogation signal may be varied. In this manner, a sequence of data may be provided to an RFID tag reader.

The method may begin at step 1202. In step 1202, the RFID tag reader may transmit (e.g., send) an interrogation signal. The interrogation signal may be an RF signal. The interrogation signal may be a scanning signal. The interrogation signal may be transmitted at or in the direction of an RFID tag. The interrogation signal may comprise a continuous waveform signal of a particular RF frequency.

In step 1204, the RFID tag reader may determine if a responsive signal is received. The responsive signal may be a backscattered signal. The responsive signal may be a backscattered version of the interrogation signal transmitted in step 1202. The responsive signal may be modulated.

If the RFID tag reader determines that a responsive signal is not received in step 1204, step 1206 may be performed. In step 1206, as a responsive signal was expected to be received in step 1204, the RFID tag reader may report an error. The error may be reported to a user of the RFID tag reader. Alternatively or in addition thereto, the error may be reported to a remote user and/or a remote computing device communicatively coupled to the RFID tag reader. The error may be reported on a user interface associated with the RFID tag reader. The error may be reported using any combination of visual, audible, and/or tactile indications. After reporting the error in step 1206, step 1202 may be repeated (e.g., if a user of the RFID tag reader determines to scan another RFID tag or the same RFID tag again).

If the RFID tag reader determines that a responsive signal is received in step 1204, step 1208 may be performed. In step 1208, the RFID tag reader may recover and store any data provided in the received signal. The RFID tag reader may demodulate the received signal to detect the data provided via the received signal. The data recovered may be any type of data and may include, for example, a bit sequence. The recovered bit sequence may be stored in a memory.

In step 1210, a determination may be made (e.g., by a user of the RFID tag reader or by an automatic process controlling the RFID tag reader) as to whether the RFID tag reader is to send another interrogation signal. For example, the method of FIG. 12 may be implemented for the RFID tag reader to receive two data signals from an RFID tag. Accordingly, after transmitting a first interrogation signal and receiving first data in response thereto, the RFID tag reader may perform step 1202 to transmit a second interrogation signal in order to receive second data in response thereto. This operation may be applicable to any number of data sequences expected to be received from the RFID tag (e.g., a single data sequence or a data sequence comprising N different data signals).

If it is determined not to send another interrogation signal, step 1212 may be performed. In step 1212, the RFID tag reader may attempt to match the stored data received from the RFID tag with a predetermined command or instruction. For example, in response to a first interrogation signal, the RFID tag reader may receive first data from the RFID tag and in response to a second interrogation signal, the RFID tag reader may receive second data from the RFID tag. The RFID tag reader and the RFID tag may operate so as to both expect to communicate using first data and second data (as opposed to just the first data or additional data). The first data may be a binary sequence such as “010” and the second data may be a binary sequence “101.” The first data and the second data may be recovered by the RFID tag reader demodulating and/or processing a first data signal from the RFID tag and a second data signal from the RFID tag, respectively. The RFID tag may send different data signals based on a change in its orientation. The RFID tag reader may combine the data sequences to form a combined binary sequence “010101.” This data sequence may be compared to a set of stored data sequences, with each stored data sequence corresponding to a specific ID, command, instruction, request, etc. from the RFID tag. As an example, the combined binary sequence “010101” may be determined to be a valid command for authorizing a financial transaction. If the data from the RFID tag is determined to match a valid command or instruction in step 1212, step 1214 may be performed.

In step 1214, the RFID tag reader may forward the determined command from step 1212 to any other computing device and/or may further cause the command from the RFID tag to be implemented. For example, the RFID tag reader may forward the command to authorize a financial transaction to a POS terminal, a remote financial computing device, or any other device to which it may be communicatively coupled. The RFID tag reader may also provide one or more indications that the data from the RFID tag was successfully interpreted as a valid command. From step 1214, step 1202 may be repeated (e.g., if it is determined that the RFID tag reader is to scan another RFID tag).

If the data from the RFID tag is not determined to match a valid command or instruction in step 1212, step 1206 may be performed. In step 1206, an error may be reported by the RFID tag reader to a user that a valid instruction or command was not determined. After step 1206, step 1202 may be performed (e.g., if another attempt at scanning the tag, or scanning another RFID tag, is desired).

The method described in FIG. 12 may be used to allow the RFID tag to send data using any number of discrete data components, such that an RFID tag reader that receives the discrete data components may combine them to determine any information that the RFID intended to provide. This capability further increases the security of the RFID tag and any information stored thereon, as a bad actor would need to know a sequence of different RFID tag orientations to obtain sensitive data from the RFID tag.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only, and is not limiting.

1. A method comprising:
receiving, by a passive radio-frequency identification (RFID) tag, a radio-frequency (RF) input signal;
determining, based on receiving the RF input signal, an orientation of the RFID tag;
selecting, based on the determined orientation of the RFID tag, a data sequence; and
transmitting an RF output signal based on the selected data sequence.

2. The method of claim 1, further comprising generating the RF output signal by modulating the RF input signal based on the selected data sequence.

3. The method of claim 1, wherein selecting the data sequence further comprises selecting the data sequence from a plurality of data sequences, each data sequence corresponding to a different orientation of the RFID tag.

4. The method of claim 1, wherein determining the orientation of the RFID tag further comprises determining the orientation of the RFID tag based on a state of a tilt switch.

5. The method of claim 1, wherein determining the orientation of the RFID tag further comprises determining the orientation of the RFID tag based on a plurality of tilt switches.

6. The method of claim 1, further comprising:
receiving a second RF input signal;
determining, based on receiving the second RF input signal, a second orientation of the RFID tag;
selecting, based on the determined second orientation of the RFID tag, a second data sequence; and
transmitting a second RF output signal based on the selected second data sequence.

7. The method of claim 6, wherein the RF output signal indicates that a first financial transaction is to be authorized and the second RF output signal indicates that a second financial transaction is unauthorized.

8. The method of claim 6, further comprising:
receiving a third RF input signal;
determining, based on receiving the third RF input signal, that the RFID tag is positioned in the second orientation;
detecting, based on receiving the third RF input signal, a temperature associated with the RFID tag;
selecting, based on the detected temperature associated with the RFID tag and based on determining that the RFID tag is positioned in the second orientation, a third data sequence; and
transmitting a third RF output signal based on the selected third data sequence.

9. A radio-frequency identification (RFID) tag comprising:
an antenna configured to receive a radio-frequency (RF) input signal;
a power circuit configured to generate power based on the received RF input signal;
one or more orientation sensors configured to detect at least a first orientation of the RFID tag and a second orientation of the RFID tag; and
a controller configured to:
receive the power generated by the power circuit;
cause output, via the antenna, of a first RF output signal based on the first orientation of the RFID tag; and
cause output, via the antenna, of a second RF output signal based on the second orientation of the RFID tag, wherein the second RF output signal is different from the first RF output signal.

10. The RFID tag of claim 9, further comprising a memory communicatively coupled to the controller and storing first data corresponding to the first orientation of the RFID tag and second data corresponding to the second orientation of the RFID tag, wherein the controller is configured to:
cause the output of the first RF output signal by causing, based on detection of the first orientation and based on the first data, output of the first RF output signal; and
cause the output of the second RF output signal by causing, based on detection of the second orientation and based on the second data, output of the second RF output signal.

11. The RFID tag of claim 9, further comprising a temperature detection switch communicatively coupled to the controller and configured to detect a temperature associated with the RFID tag, wherein the controller is configured to:
cause the output of the first RF output signal by causing, based on detection of the first orientation and based on the detected temperature associated with the RFID tag, output of the first RF output signal; and
cause the output of the second RF output signal by causing, based on detection of the second orientation and based on the detected temperature associated with the RFID tag, output of the second RF output signal.

12. The RFID tag of claim 9, wherein the RFID tag comprises a passive RFID tag.

13. The RFID tag of claim 9, wherein the one or more orientation sensors comprise a tilt switch.

14. The RFID tag of claim 9, wherein the first RF output signal and the second RF output signal each indicate one or more of:
a unique identification (ID) code;
a command;
an instruction; or
a request.

15. The RFID tag of claim 9, wherein the one or more orientation sensors are configured to detect an orientation comprising rotations about three axes.

16. A method comprising:
receiving, by a radio-frequency identification (RFID) tag comprising an orientation sensor, a first radio-frequency (RF) input signal;
transmitting, by the RFID tag and based a first orientation of the RFID tag, a first RF output signal;
receiving, by the RFID tag, a second radio-frequency RF input signal; and
transmitting, by the RFID tag and based on a second orientation of the RFID tag, a second RF output signal, wherein the second RF output signal is different from the first RF output signal.

17. The method of claim 16, further comprising:
determining, based on a first state of one or more orientation sensors, the first orientation of the RFID tag; and
determining, based on a second state of the one or more orientation sensors, the second orientation of the RFID tag.

18. The method of claim 16, wherein:
transmitting the first RF output signal further comprises transmitting the first RF output signal based on a detected temperature associated with the RFID tag; and
transmitting the second RF output signal further comprises transmitting the second RF output signal based on the detected temperature associated with the RFID tag.

19. The method of claim 16, wherein:
transmitting the first RF output signal further comprises modulating the first RF input signal based on first data corresponding to the first orientation; and
transmitting the second RF output signal further comprises modulating the second RF input signal based on second data corresponding to the second orientation.

20. The method of claim 16, wherein the RFID tag is a passive RFID tag.
